(19) United States
(12) Patent Application Publication
(10) Pub. No.: US 2012/0281197 A1
(43) Pub. Date: Nov. 8, 2012

(54) Holographic Mask Inspection System with Spatial Filter

(75) Inventors: Robert Albert Tharaldsen, Sherman, CT (US); Arie Jeffrey Den Boef, Waalre (NL); Eric Brian Catey, Danbury, CT (US); Yevgeniy Konstantinovich Shmarev, Lagrangeville, NY (US); Richard David Jacobs, Brookfield, CT (US)

(73) Assignees: ASML NETHERLANDS B.V., Veldhoven (NL); ASML HOLDINGS N.V., Veldhoven (NL)

(21) Appl. No.: 13/497,178

(22) PCT Filed: Nov. 12, 2010
(86) PCT No.: PCT/EP10/67362

§ 371 Date: Mar. 20, 2012

Related U.S. Application Data
(60) Provisional application No. 61/298,792, filed on Jan. 27, 2010.

(51) Int. Cl. G03H 1/02; G03B 27/72

(52) U.S. Cl. 355/71; 359/30; 359/31

(57) ABSTRACT

Disclosed are apparatuses, methods, and lithographic systems for holographic mask inspection. A holographic mask inspection system (300, 600, 700) includes an illumination source (330), a spatial filter (350), and an image sensor (380). The illumination source being configured to illuminate a radiation beam (331) onto a target portion of a mask (310). The spatial filter (350) being arranged in a Fourier transform pupil plane of an optical system (390, 610, 710), where the spatial filter receives at least a portion of a reflected radiation beam (311) from the target portion of the mask. The optical system being arranged to combine (360, 660, 740) the portion of the reflected radiation beam (311) with a reference radiation beam (361, 331) to generate a combined radiation beam. Further, the image sensor (380) being configured to capture holographic image of the combined radiation beam. The image may contain one or more mask defects.

### CROSS-REFERENCE TO RELATED APPLICATIONS

This application claims the benefit of U.S. provisional application 61/298,792 which was filed on 27 Jan. 2010, and which is incorporated herein in its entirety by reference.

### FIELD

Embodiments of the present invention generally relate to lithography, and more particularly to a holographic mask inspection system with a spatial filter.

### BACKGROUND

Lithography is widely recognized as a key process in manufacturing integrated circuits (ICs) as well as other devices and/or structures. A lithographic apparatus is a machine, used during lithography, which applies a desired pattern onto a substrate, such as onto a target portion of the substrate. During manufacture of ICs with a lithographic apparatus, a patterning device (which is alternatively referred to as a mask or a reticle) generates a circuit pattern to be formed on an individual layer in an IC. This pattern can be transferred onto the target portion (e.g., comprising part of, one, or several dies) on the substrate (e.g., a silicon wafer). Transfer of the pattern is typically via imaging onto a layer of radiation-sensitive material (e.g., resist) provided on the substrate. In general, a single substrate contains a network of adjacent target portions that are successively patterned. Manufacturing different layers of the IC often requires imaging different patterns on different layers with different masks.

As the dimensions of ICs decrease and the patterns being transferred from the mask to the substrate become more complex, defects in the features formed on the mask become increasingly important. Consequently, defects in the features formed on the mask translate into pattern defects formed on the substrate. Mask defects can come from a variety of sources such as, for example, defects in coatings on mask blanks, the mask patterning process in a mask shop, and mask handling and contamination defects in a wafer fabrication facility. Therefore, inspection of masks for defects is important to minimize or remove unwanted particles and contaminants from affecting the transfer of a mask pattern onto the substrate.

Holography is a method that can be used to monitor for mask defects. For instance, a hologram can be generated by interfering an object beam with a reference beam, such that the resultant field can be recorded on an image sensor such as, for example, a silicon charge-coupled device (CCD) with an array of sensors. At a later time, the object can be reconstructed, where phase and amplitude information from the reconstructed object can be examined to determine the existence of defects.

Holographic imaging of target portions of a mask is difficult because small particles on the mask (e.g., mask defects) can result in a small signal-to-noise ratio of resultant fields recorded by the image sensor. In other words, the amount of energy that is reflected back from the small particles to the image sensor is oftentimes much smaller than a fluctuation in the background DC signal (e.g., from the mask area that surrounds the small particles), which is also reflected back to the image sensor.

Another issue with holographic imaging of small particles, such as mask defects, concerns registration errors when subtracting a reference image from the holographic image corresponding to the resultant field to determine differences between the two images. A difference between the reference and resultant images can indicate the presence of mask defects. However, if the reference and resultant images contain a pattern that is offset by some random amount between the two images, the residue of the difference between these images can be significantly greater than the signal from a nearby particle.

Apparatuses, methods, and systems are needed to overcome the above-noted issues with holographic monitoring of mask defects.

### SUMMARY

Given the foregoing, what is needed is an improved holographic mask inspection system to support the minimization or removal of defects from mask patterns transferred onto a substrate. To meet this need, embodiments of the present invention are directed to a holographic mask inspection system with a spatial filter.

Embodiments of the present invention include a holographic mask inspection system. The holographic mask inspection system includes an illumination source configured to illuminate a radiation beam onto a target portion of a mask. The holographic mask inspection system also includes a spatial filter arranged in a pupil plane of an optical system. The spatial filter receives at least a portion of a reflected radiation beam from the target portion of the mask. The optical system combines the portion of the reflected radiation beam with a reference radiation beam to generate a combined radiation beam. Further, the holographic mask inspection system includes an image sensor configured to capture an image of the combined radiation beam.

Embodiments of the present invention additionally include a method for inspecting a mask for defects. The method includes the following: illuminating a radiation beam onto target portion of a mask; receiving at least a portion of a reflected radiation beam from the target portion of the mask, where the portion of the reflected radiation beam passes through a spatial filter arranged in a pupil plane of an optical system; combining the portion of the reflected radiation beam from the spatial filter with a reference radiation beam to generate a combined radiation beam; and, detecting an image corresponding to the combined radiation beam.

Embodiments of the present invention further include a lithography system with a holographic mask inspection system. The lithography system includes the following components: a first illumination system; a support; a substrate table; a projection system; and, a holographic mask inspection system. The holographic mask inspection includes a second illumination source, a spatial filter arranged in a pupil plane of an optical system, and an image sensor. The spatial filter receives at least a portion of a reflected radiation beam from a target portion of a patterning device. The optical system combines the portion of the reflected radiation beam with a reference radiation beam to generate a combined radiation beam. The image sensor is configured to detect an image corresponding to the combined radiation beam.

Further features and advantages of embodiments of the invention, as well as the structure and operation of various embodiments of the present invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of embodiments of the invention and to enable a person skilled in the relevant art(s) to make and use embodiments of the invention.

FIG. 1A is an illustration of an example reflective lithographic apparatus, in which embodiments of the present invention can be implemented.

FIG. 1B is an illustration of an example transmissive lithographic apparatus, in which embodiments of the present invention can be implemented.

FIG. 2 is an illustration of an example EUV lithographic apparatus, in which embodiments of the present invention can be implemented.

FIG. 3 is an illustration of an embodiment of a holographic mask inspection system.

FIG. 4 is an illustration of an example reticle with an example periodic reticle pattern disposed thereon.

FIG. 5 is an illustration of an example spatial filter with images of a Fourier transform plane in an optical system of a holographic mask inspection system before and after placement of the spatial filter in the Fourier transform plane.

FIG. 6 is an illustration of another embodiment of another holographic mask inspection system.

FIG. 7 is an illustration of an embodiment of yet another holographic mask inspection system.

FIG. 8 is an illustration of an embodiment of a method for holographic mask inspection.

The features and advantages of embodiments of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Overview

Embodiments of the present invention are directed to a holographic mask inspection system. This specification discloses one or more embodiments that incorporate the features of embodiments of the present invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the present invention are directed to a holographic mask inspection system. The holographic mask inspection system can be used to resolve issues in typical holographic mask inspection systems such as, for example and without limitation, small signal-to-noise ratios of resultant fields that are used to generate the holographic image and registration errors. In an embodiment, these issues can be resolved by placing a spatial filter in a Fourier transform plane or pupil plane of an optical system in the holographic mask inspection system. The spatial filter can remove spectral components associated with a diffraction pattern of light reflected off a mask defect, which in turn can improve the signal-to-noise ratios of resultant fields and registration errors.

Before describing such embodiments in more detail, however, it is instructive to present an example environment in which embodiments of the present invention can be implemented.

### II. An Example Lithographic Environment

A. Example Reflective and Transmissive Lithographic Systems

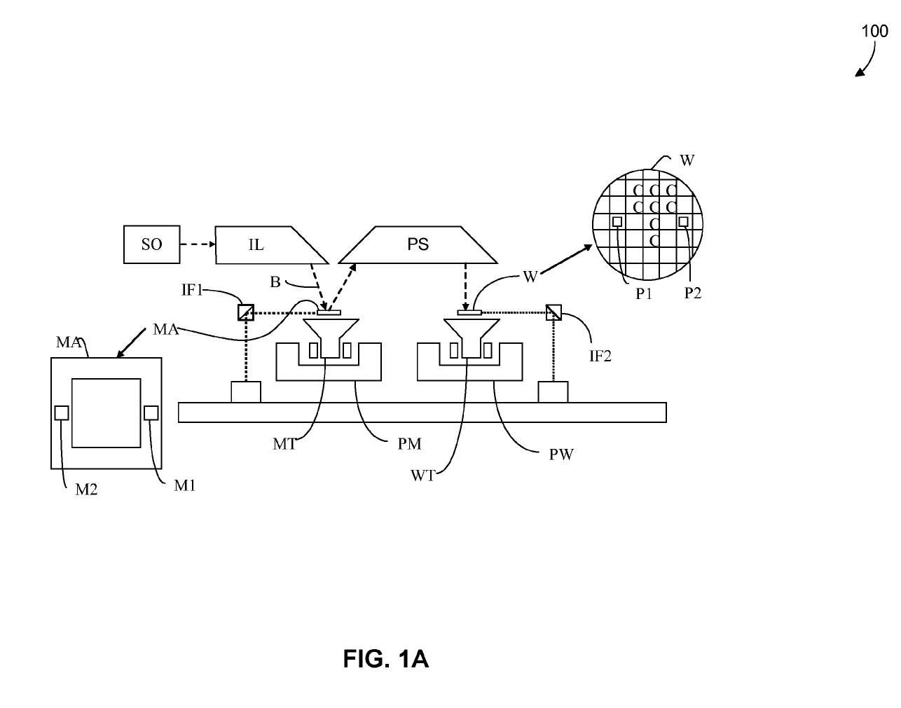

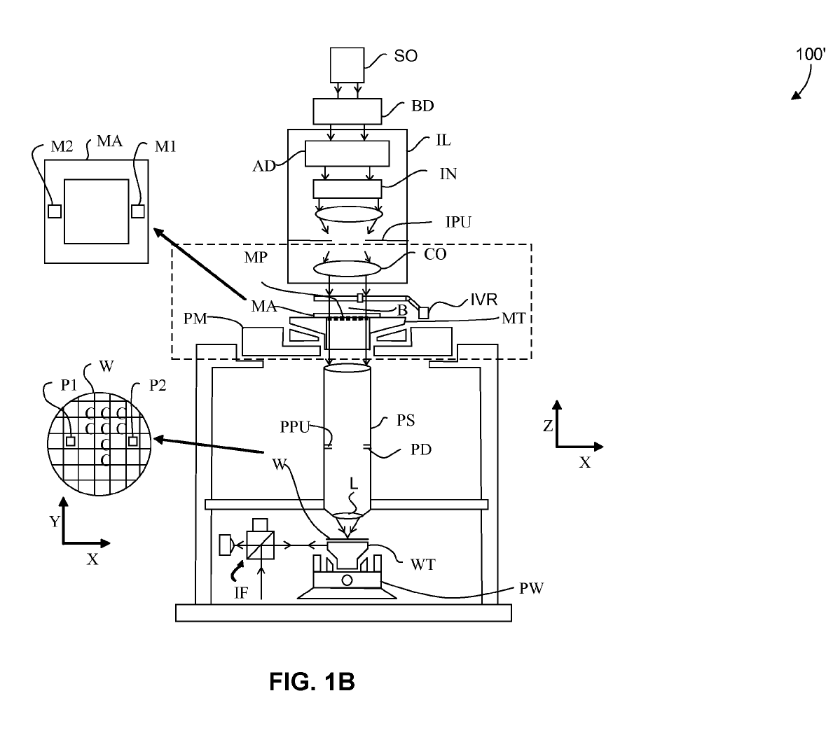

FIGS. 1A and 1B schematically depict lithographic apparatus 100 and lithographic apparatus 100′, respectively. Lithographic apparatus 100 and lithographic apparatus 100′ each include: an illumination system (illuminator) IL configured to condition a radiation beam B (e.g., DUV or EUV radiation); a support structure (e.g., a mask table) MT configured to support a patterning device (e.g., a mask, a reticle, or a dynamic patterning device) MA and connected to a first positioner PM configured to accurately position the patterning device MA; and a substrate table (e.g., a wafer table) WT configured to hold a substrate (e.g., a resist coated wafer) W and connected to a second positioner PW configured to accurately position the substrate W. Lithographic apparatuses 100 and 100′ also have a projection system PS configured to project a pattern imparted to the radiation beam B by patterning device MA onto a target portion (e.g., comprising one or more dies) C of the substrate W. In lithographic apparatus 100 the patterning device MA and the projection system PS is reflective, and in lithographic apparatus 100′ the patterning device MA and the projection system PS is transmissive.

The illumination system IL may include various types of optical components, such as refractive, reflective, magnetic, electromagnetic, electrostatic or other types of optical components, or any combination thereof, for directing, shaping, or controlling the radiation B.

The support structure MT holds the patterning device MA in a manner that depends on the orientation of the patterning device MA, the design of the lithographic apparatuses 100 and 100′, and other conditions, such as for example whether or not the patterning device MA is held in a vacuum environment. The support structure MT may use mechanical, vacuum, electrostatic or other clamping techniques to hold the patterning device MA. The support structure MT may be a frame or a table, for example, which may be fixed or movable, as required. The support structure MT may ensure that the patterning device is at a desired position, for example with respect to the projection system PS.

The term “patterning device” MA should be broadly interpreted as referring to any device that may be used to impart a radiation beam B with a pattern in its cross-section, such as to create a pattern in the target portion C of the substrate W. The pattern imparted to the radiation beam B may correspond to a particular functional layer in a device being created in the target portion C, such as an integrated circuit.

The patterning device MA may be transmissive (as in lithographic apparatus 100′ of FIG. 1B) or reflective (as in lithographic apparatus 100 of FIG. 1A). Examples of patterning devices MA include reticles, masks, programmable mirror arrays, and programmable LCD panels. Masks are well known in lithography, and include mask types such as binary, alternating phase shift, and attenuated phase shift, as well as various hybrid mask types. An example of a programmable mirror array employs a matrix arrangement of small mirrors, each of which may be individually tilted so as to reflect an incoming radiation beam in different directions. The tilted mirrors impart a pattern in the radiation beam B, which is reflected by the mirror matrix.

The term “projection system” PS may encompass any type of projection system, including refractive, reflective, catadioptric, magnetic, electromagnetic and electrostatic optical systems, or any combination thereof, as appropriate for the exposure radiation being used, or for other factors, such as the use of an immersion liquid or the use of a vacuum. A vacuum environment may be used for EUV or electron beam radiation since other gases may absorb too much radiation or electrons. A vacuum environment may therefore be provided to the whole beam path with the aid of a vacuum wall and vacuum pumps.

Lithographic apparatus 100 and/or lithographic apparatus 100′ may be of a type having two (dual stage) or more substrate tables (and/or two or more mask tables) WT. In such “multiple stage” machines the additional substrate tables WT may be used in parallel, or preparatory steps may be carried out on one or more tables while one or more other substrate tables WT are being used for exposure.

Referring to FIGS. 1A and 1B, the illuminator IL receives a radiation beam from a radiation source SO. The source SO and the lithographic apparatuses 100, 100′ may be separate entities, for example when the source SO is an excimer laser. In such cases, the source SO is not considered to form part of the lithographic apparatuses 100 or 100′, and the radiation beam B passes from the source SO to the illuminator IL with the aid of a beam delivery system BD (FIG. 1B) comprising, for example, suitable directing mirrors and/or a beam expander. In other cases, the source SO may be an integral part of the lithographic apparatuses 100, 100′—for example when the source SO is a mercury lamp. The source SO and the illuminator IL, together with the beam delivery system BD, if required, may be referred to as a radiation system.

The illuminator IL may comprise an adjuster AD (FIG. 1B) for adjusting the angular intensity distribution of the radiation beam. Generally, at least the outer and/or inner radial extent (commonly referred to as σ-outer and σ-inner, respectively) of the intensity distribution in a pupil plane of the illuminator may be adjusted. In addition, the illuminator IL may comprise various other components (FIG. 1B), such as an integrator IN and a condenser CO. The illuminator IL may be used to condition the radiation beam B, to have a desired uniformity and intensity distribution in its cross section.

Referring to FIG. 1A, the radiation beam B is incident on the patterning device (e.g., mask) MA, which is held on the support structure (e.g., mask table) MT, and is patterned by the patterning device MA. In lithographic apparatus 100, the radiation beam B is reflected from the patterning device (e.g., mask) MA. After being reflected from the patterning device (e.g., mask) MA, the radiation beam B passes through the projection system PS, which focuses the radiation beam B onto a target portion C of the substrate W. With the aid of the second positioner PW and position sensor IF2 (e.g., an interferometric device, linear encoder or capacitive sensor), the substrate table WT may be moved accurately, e.g. so as to position different target portions C in the path of the radiation beam B. Similarly, the first positioner PM and another position sensor IF1 may be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

Referring to FIG. 1B, the radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1B) can be used to accurately position the mask MA with respect to the path of the radiation beam B, e.g., after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (known as scribe-lane alignment marks). Similarly, in situations in which more than one die is provided on the mask MA, the mask alignment marks may be located between the dies.

The lithographic apparatuses 100 and 100′ may be used in at least one of the following modes:

1. In step mode, the support structure (e.g., mask table) MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C may be exposed.

2. In scan mode, the support structure (e.g., mask table) MT and the substrate table WT are scanned synchronously while a pattern imparted to the radiation beam B is projected onto a target portion C (i.e., a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept substantially stationary holding a programmable patterning device, and the substrate table WT is moved or scanned while a pattern imparted to the radiation beam B is projected onto a target portion C. A pulsed radiation source SO may be employed and the programmable patterning device is updated as required after each movement of the substrate table WT or in between successive radiation pulses during a scan. This mode of operation may be readily applied to maskless lithography that utilizes programmable patterning device, such as a programmable mirror array of a type as referred to herein.

Combinations and/or variations on the described modes of use or entirely different modes of use may also be employed.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

In a further embodiment, lithographic apparatus 100 includes an extreme ultraviolet (EUV) source, which is configured to generate a beam of EUV radiation for EUV lithography. In general, the EUV source is configured in a radiation system (see below), and a corresponding illumination system is configured to condition the EUV radiation beam of the EUV source.

B. Example EUV Lithographic Apparatus

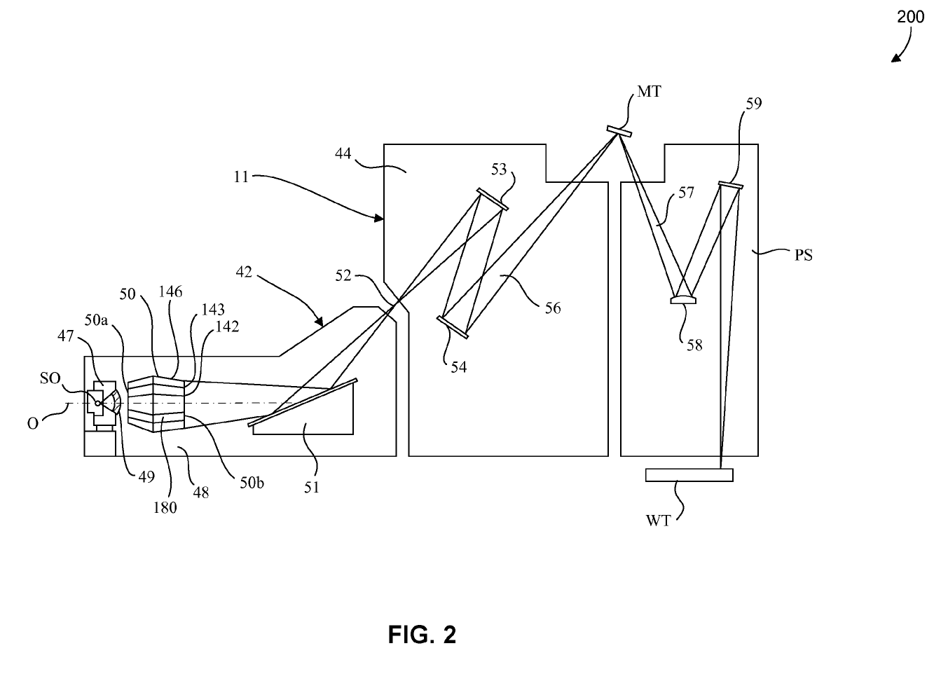

FIG. 2 schematically depicts an exemplary EUV lithographic apparatus 200 according to an embodiment of the present invention. In FIG. 2, EUV lithographic apparatus 200 includes a radiation system 42, an illumination optics unit 44, and a projection system PS. The radiation system 42 includes a radiation source SO, in which a beam of radiation may be formed by a discharge plasma. In an embodiment, EUV radiation may be produced by a gas or vapor, for example, from Xe gas, Li vapor, or Sn vapor, in which a very hot plasma is created to emit radiation in the EUV range of the electromagnetic spectrum. The very hot plasma can be created by generating at least partially ionized plasma by, for example, an electrical discharge. Partial pressures of, for example, 10 Pa of Xe, Li, Sn vapor or any other suitable gas or vapor may be required for efficient generation of the radiation. The radiation emitted by radiation source SO is passed from a source chamber 47 into a collector chamber 48 via a gas barrier or contaminant trap 49 positioned in or behind an opening in source chamber 47. In an embodiment, gas barrier 49 may include a channel structure.

Collector chamber 48 includes a radiation collector 50 (which may also be called collector mirror or collector) that may be formed from a grazing incidence collector. Radiation collector 50 has an upstream radiation collector side 50a and a downstream radiation collector side 50b, and radiation passed by collector 50 can be reflected off a grating spectral filter 51 to be focused at a virtual source point 52 at an aperture in the collector chamber 48. Radiation collectors 50 are known to skilled artisans.

From collector chamber 48, a beam of radiation 56 is reflected in illumination optics unit 44 via normal incidence reflectors 53 and 54 onto a reticle or mask (not shown) positioned on reticle or mask table MT. A patterned beam 57 is formed, which is imaged in projection system PS via reflective elements 58 and 59 onto a substrate (not shown) supported on wafer stage or substrate table WT. In various embodiments, illumination optics unit 44 and projection system PS may include more (or fewer) elements than depicted in FIG. 2. For example, grating spectral filter 51 may optionally be present, depending upon the type of lithographic apparatus. Further, in an embodiment, illumination optics unit 44 and projection system PS may include more mirrors than those depicted in FIG. 2. For example, projection system PS may incorporate one to four reflective elements in addition to reflective elements 58 and 59. In FIG. 2, reference number 180 indicates a space between two reflectors, e.g., a space between reflectors 142 and 143.

In an embodiment, collector mirror 50 may also include a normal incidence collector in place of or in addition to a grazing incidence mirror. Further, collector mirror 50, although described in reference to a nested collector with reflectors 142, 143, and 146, is herein further used as example of a collector.

Further, instead of a grating 51, as schematically depicted in FIG. 2, a transmissive optical filter may also be applied. Optical filters transmissive for EUV, as well as optical filters less transmissive for or even substantially absorbing UV radiation, are known to skilled artisans. Hence, the use of “grating spectral purity filter” is herein further indicated interchangeably as a “spectral purity filter,” which includes gratings or transmissive filters. Although not depicted in FIG. 2, EUV transmissive optical filters may be included as additional optical elements, for example, configured upstream of collector mirror 50 or optical EUV transmissive filters in illumination unit 44 and/or projection system PS.

The terms “upstream” and “downstream,” with respect to optical elements, indicate positions of one or more optical elements “optically upstream” and “optically downstream,” respectively, of one or more additional optical elements. Following the light path that a beam of radiation traverses through lithographic apparatus 200, a first optical elements closer to source SO than a second optical element is configured upstream of the second optical element; the second optical element is configured downstream of the first optical element. For example, collector mirror 50 is configured upstream of spectral filter 51, whereas optical element 53 is configured downstream of spectral filter 51.

All optical elements depicted in FIG. 2 (and additional optical elements not shown in the schematic drawing of this embodiment) may be vulnerable to deposition of contaminants produced by source SO, for example, Sn. Such may be the case for the radiation collector 50 and, if present, the spectral purity filter 51. Hence, a cleaning device may be employed to clean one or more of these optical elements, as well as a cleaning method may be applied to those optical elements, but also to normal incidence reflectors 53 and 54 and reflective elements 58 and 59 or other optical elements, for example additional mirrors, gratings, etc.

Radiation collector 50 can be a grazing incidence collector, and in such an embodiment, collector 50 is aligned along an optical axis O. The source SO, or an image thereof, may also be located along optical axis O. The radiation collector 50 may comprise reflectors 142, 143, and 146 (also known as a “shell” or a Wolter-type reflector including several Wolter-type reflectors). Reflectors 142, 143, and 146 may be nested and rotationally symmetric about optical axis O. In FIG. 2, an inner reflector is indicated by reference number 142, an intermediate reflector is indicated by reference number 143, and an outer reflector is indicated by reference number 146. The radiation collector 50 encloses a certain volume, i.e., a volume within the outer reflector(s) 146. Usually, the volume within outer reflector(s) 146 is circumferentially closed, although small openings may be present.

Reflectors 142, 143, and 146 respectively may include surfaces of which at least portion represents a reflective layer or a number of reflective layers. Hence, reflectors 142, 143, and 146 (or additional reflectors in the embodiments of radiation collectors having more than three reflectors or shells) are at least partly designed for reflecting and collecting EUV radiation from source SO, and at least part of reflectors 142, 143, and 146 may not be designed to reflect and collect EUV radiation. For example, at least part of the back side of the reflectors may not be designed to reflect and collect EUV radiation. On the surface of these reflective layers, there may in addition be a cap layer for protection or as optical filter provided on at least part of the surface of the reflective layers.

The radiation collector 50 may be placed in the vicinity of the source SO or an image of the source SO. Each reflector 142, 143, and 146 may comprise at least two adjacent reflecting surfaces, the reflecting surfaces further from the source SO being placed at smaller angles to the optical axis O than the reflecting surface that is closer to the source SO. In this way, a grazing incidence collector 50 is configured to generate a beam of (E)UV radiation propagating along the optical axis O. At least two reflectors may be placed substantially coaxially and extend substantially rotationally symmetric about the optical axis O. It should be appreciated that radiation collector 50 may have further features on the external surface of outer reflector 146 or further features around outer reflector 146, for example a protective holder, a heater, etc.

In the embodiments described herein, the terms “lens” and “lens element,” where the context allows, may refer to any one or combination of various types of optical components, comprising refractive, reflective, magnetic, electromagnetic and electrostatic optical components.

Further, the terms “radiation” and “beam” used herein encompass all types of electromagnetic radiation, comprising ultraviolet (UV) radiation (e.g., having a wavelength λ of 365, 248, 193, 157 or 126 nm), extreme ultra-violet (EUV or soft X-ray) radiation (e.g., having a wavelength in the range of 5-20 nm, e.g., 13.5 nm), or hard X-ray working at less than 5 nm, as well as particle beams, such as ion beams or electron beams. Generally, radiation having wavelengths between about 780-3000 nm (or larger) is considered IR radiation. UV refers to radiation with wavelengths of approximately 100-400 nm. Within lithography, it is usually also applied to the wavelengths, which can be produced by a mercury discharge lamp: G-line 436 nm; H-line 405 nm; and/or I-line 365 nm. Vacuum UV, or VUV (i.e., UV absorbed by air), refers to radiation having a wavelength of approximately 100-200 nm. Deep UV (DUV) generally refers to radiation having wavelengths ranging from 126 nm to 428 nm, and in an embodiment, an excimer laser can generate DUV radiation used within lithographic apparatus. It should be appreciated that radiation having a wavelength in the range of, for example, 5-20 nm relates to radiation with a certain wavelength band, of which at least part is in the range of 5-20 nm.

### III. Embodiments of a Holographic Mask Inspection System

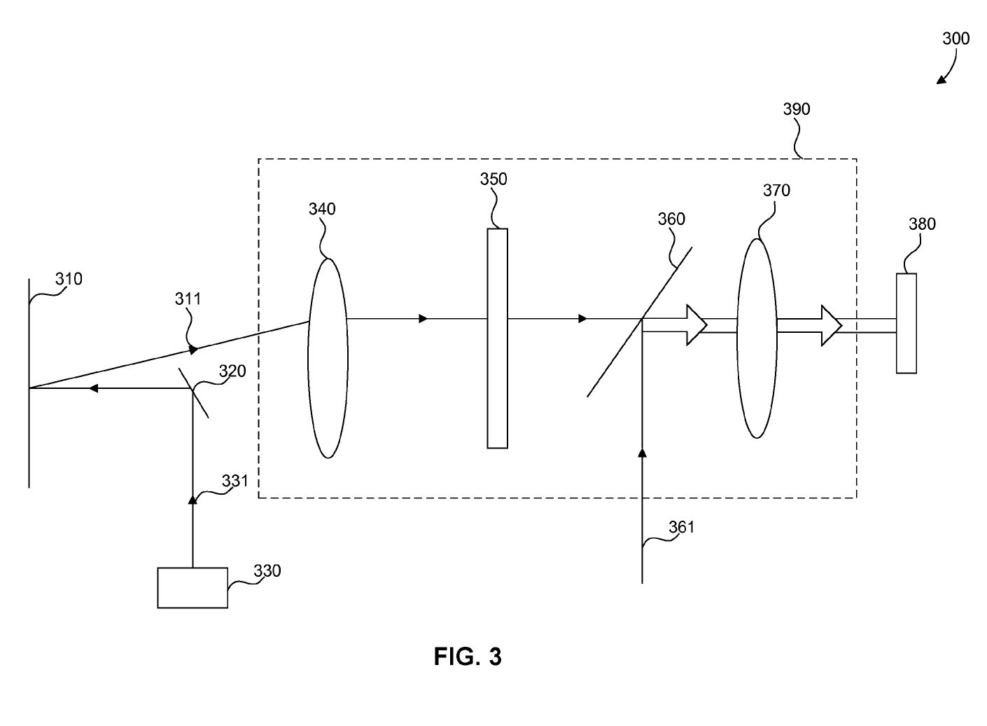

FIG. 3 is an illustration of an embodiment of a holographic mask inspection system 300. Holographic mask inspection system 300 includes a mirror 320, an illumination source 330, an objective lens 340, a spatial filter 350, a beam combiner 360, a tube lens 370, and an image sensor 380. Objective lens 340, spatial filter 350, beam combiner 360, and tube lens 370 are also collectively referred to herein as an optical system 390 of holographic mask inspection system 300. The terms “reticle” and “mask” are used interchangeably in the description herein.

It is well-known in the field of Fourier optics that, for certain optical systems (e.g., optical system 390 of FIG. 3), a pupil of the optical system represents an optical Fourier transform of any object pattern. In the action of optically transforming the object, spatial frequencies of energy in the object are transformed to spatial locations within the pupil. As a result of the transforming operation, a substantial portion of the energy (e.g., a majority of the energy) diffracted from the reticle will be mapped to specific spatial locations within the pupil.

It is also well-known in the field of Fourier optics that small particles (e.g., defects on the reticle) scatter incident energy fairly uniformly over all angles. As a consequence, the energy from the particle that is collected by the optical system (e.g., optical system 390 of FIG. 3) will be spread fairly uniformly across the pupil of the optical system. In an embodiment of the present invention, by introducing a spatial filter into the pupil plane of the optical system (also referred to herein as the Fourier transform plane of the optical system), it is possible to remove a significant amount of energy from the image background while leaving a significant amount of the particle's energy to reform the image.

One use of holographic mask inspection system 300, among others, is to generate a hologram image of one or more target portions of a given reticle 310, as illustrated in FIG. 3. The hologram images of reticle 310 can then be compared to one or more corresponding images of a reference or ideal reticle pattern to determine the presence of mask defects. As noted in the introduction section above, typical holographic mask inspection systems are faced with issues such as, for example and without limitation, small signal-to-noise ratios in the resultant fields used to generate the holographic image and registration errors. A goal of holographic mask inspection system 300, among others, is to resolve these issues and other issues in typical holographic mask inspection systems. Based on the description herein, a person of ordinary skill in the art will recognize that holographic mask inspection system 300 can be used to resolve holographic issues other than small signal-to-noise ratios in resultant fields and registration errors.

In an embodiment, holographic mask inspection system 300 can be a stand-alone system that operates in conjunction with the reflective lithographic apparatus of FIG. 1A, the transmissive lithographic apparatus of FIG. 1B, or the EUV lithographic apparatus of FIG. 2. In another embodiment, holographic mask inspection system 300 can be integrated in either the reflective lithographic apparatus of FIG. 1A, the transmissive lithographic apparatus of FIG. 1B, or the EUV lithographic apparatus of FIG. 2. For instance, when integrated with the reflective lithographic apparatus of FIG. 1, illumination source IL of FIG. 1 can also provide an illumination source to holographic mask inspection system 300. The illumination source for holographic mask inspection system 300 (e.g., illumination source 330) is described in further detail below.

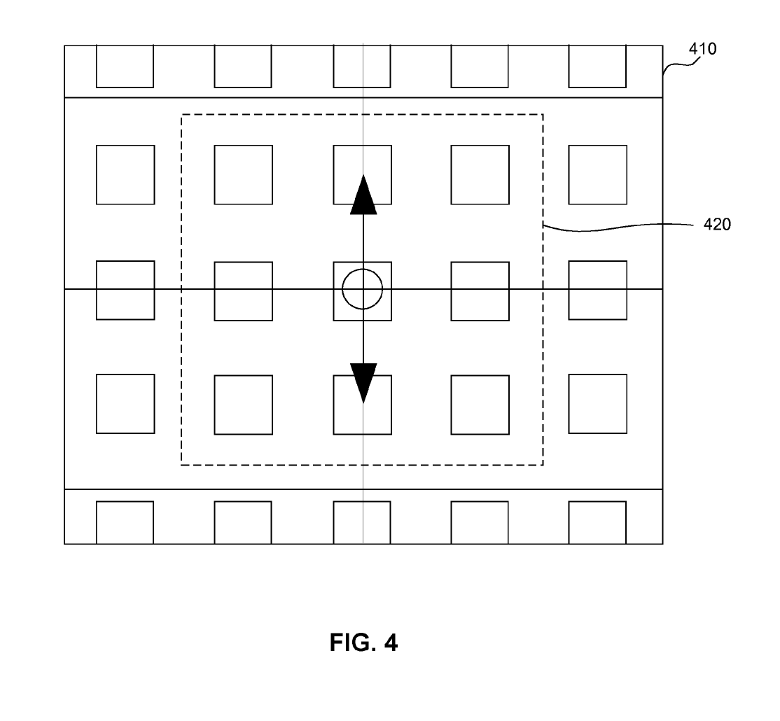

FIG. 4 is an illustration of an example reticle 410, which has a periodic reticle pattern 420 disposed thereon. For ease of explanation, reticle 410 and its periodic pattern 420 will be used to facilitate in the explanation of holographic mask inspection system 300. Based on the description herein, a person of ordinary skill in the relevant art will recognize that other reticles and reticle patterns can be used with embodiments of the present invention. These other reticles and reticle patterns are within the spirit and scope of the present invention.

Referring again to FIG. 3, illumination source 330 is configured to emit a radiation beam 331 towards mirror 320. Mirror 320 directs radiation beam 331 onto a target portion of reticle 310. The wavelength of the radiation beam can be, for example and without limitation, 266 nm. Other wavelengths can be used, as would become apparent to a person of ordinary skill in the relevant art, without departing from the spirit and scope of embodiments of the present invention.

Optical system 390 receives a portion of the reflected radiation beam 311 from the target portion of reticle 310. In an embodiment, objective lens 340 is arranged within optical system 390 to receive the portion of reflected radiation beam 311. Spatial filter 350 then receives the portion of reflected radiation beam 311 from objective lens 340, according to an embodiment of the present invention.

After the portion of reflected radiation beam 311 is filtered by spatial filter 350, beam combiner 360 receives the portion of reflected radiation beam 311, according to an embodiment of the present invention. In an embodiment, beam combiner 360 is arranged to combine the portion of reflected radiation beam 311 with a reference radiation beam 361. The combination of the portion of reflected radiation beam 311 with reference radiation beam 361 is also referred herein as a “combined radiation beam.” Reference radiation beam 361 can be, for example and without limitation, a secondary light source used to interfere with the portion of reflected radiation beam 311 from spatial filter 350. In another embodiment, reference radiation beam 361 can be generated from illumination source 330 and can also be the same type of light as radiation beam 331. In yet another embodiment, reference radiation beam 361 can be generated from an illumination source of the reflective lithographic apparatus of FIG. 1A, the transmissive lithographic apparatus of FIG. 1B, or the EUV lithographic apparatus of FIG. 2.

As understood by a person of ordinary skill in the relevant art, the resultant field generated from the interference between the portion of reflected radiation beam 311 and reference radiation beam 361 can be used to generate a hologram image of the target portion of reticle 310. The combined radiation beam (e.g., interference between the portion of reflected radiation beam 311 and reference radiation beam 361) is directed from beam combiner 360 to tube lens 370, according to an embodiment of the present invention.

In an embodiment, a portion of image sensor 380 receives the combined radiation beam from tube lens 370 and records the resultant field from the combined radiation beam. Image sensor 380 can be, for example and without limitation, a silicon charge-coupled device with an array of sensors. Based on the description herein, a person of ordinary skill in the relevant art will recognize that other types of image sensors can be used to receive and record the resultant field. These other types of image sensors are within the scope and spirit of the present invention.

The recorded resultant field from image sensor 380 can be used to generate a hologram image of the target portion of reticle 310, according to an embodiment of the present invention. In an embodiment, the hologram image can be compared to a reference image to determine the presence of mask defects.

In reference to FIG. 3, the placement of spatial filter 350 in a Fourier transform plane or a pupil plane of optical system 390 resolves the above-noted signal-to-noise ratio and registration error issues. The Fourier transform plane or pupil plane can be, for example and without limitation, located in an area between objective lens 340 and beam combiner 360, as illustrated by the placement of spatial filter 350 in optical system 390 of FIG. 3. In an embodiment, spatial filter 350 is positioned in the Fourier transform plane of optical system 390 such that one or more spatial frequency components in the image corresponding to the portion of reflected radiation beam 311 is filtered out or removed from being transmitted to beam combiner 360.

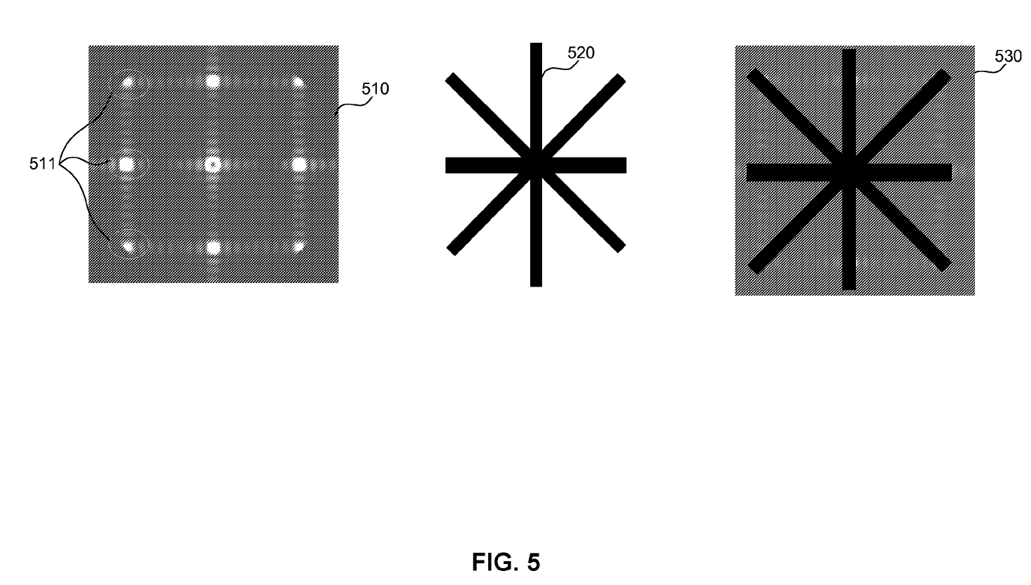

FIG. 5 is an illustration of an example spatial filter 520, an image 510 of the Fourier transform plane without placement of spatial filter 520 in the Fourier transform plane of optical system 390 in FIG. 3, and an image 530 with placement of spatial filter 520 in the Fourier transform plane. Image 510 shows example spectral components 511 that are associated with a diffraction pattern of light reflected off the target portion of reticle 310. Without spatial filter 520 arranged in the Fourier transform plane of optical system 390, spectral components 511 can be received and recorded by image sensor 380 (e.g., spectral components 511 are embodied in the portion of reflected radiation beam 311 that is received by beam combiner 360, combined with reference radiation beam 361 by beam combiner 360, and passed through tube lens 370 to image sensor 380).

Removing certain spectral components 511 from the image formed by the optical system can lead to an improvement in signal-to-noise ratio in the resultant field recorded by image sensor 380. This is because the brightest spectral components 511 in this particular example contain a majority of the energy reflected from the background of the reticle, whereas the energy from a putative particle on the reticle would be equally distributed about spectral components 511. In an embodiment, spatial filter 520 of FIG. 5 removes the background light associated with the strongest spectral components 511 related to the reticle's background. As a result, the detection of light by image sensor 380 of FIG. 3 is limited to a significantly reduced amount of light reflected from the target portion of reticle 310, in addition to most of the energy scattered from any particle present on the reticle. In other words, spatial filter 520 blocks light associated with spectral components 511 related to the reticle background from being detected by image sensor 380, according to an embodiment of the present invention. For instance, the blockage of spectral components 511 is shown in image 530 of FIG. 5, where spatial filter 520 filters out spectral components 511 from image 510. In turn, the signal-to-noise ratio of the resultant field formed at beam combiner 360 of FIG. 3 is increased, which also increases the sensitivity of image sensor 380 to detect mask defects.

Another benefit of spatial filter 520, among others, is the reduction of sensitivity to registration errors in the detection of mask defects. By removing spectral components 511 due to the background pattern with spatial filter 520, as described above, a hologram image can be generated from a resultant field (e.g., interference of the portion of reflected radiation beam 311 with reference radiation beam 361 of FIG. 3) that does not contain spectral components 511 due to the background pattern, according to an embodiment of the present invention. In an embodiment, this hologram image of the target portion of reticle 310 can be compared to a reference image to determine the presence of mask defects. However, if spectral components 511 are not filtered by spatial filter 520, then spectral components 511 become part of the hologram image of the target portion of reticle 310, which when compared to the reference image may generate a false indication of one or more mask defects. Thus, by removing spectral components 511, the placement of spatial filter 520 in the Fourier transform plane of optical system 390 in FIG. 3 not only improves a signal-to-noise ratio in a resultant field, but also reduces sensitivity to registration errors in the detection of mask defects.

In an embodiment, the pattern of spatial filter 520 depends on a predetermined diffraction pattern produced by the target portion of reticle 310 of FIG. 3. As understood by a person of ordinary skill in the relevant art, the pattern of light diffracted from the target portion of reticle 310 (e.g., spectral components 511 of FIG. 5) depends on the pattern disposed on reticle 310 (e.g., periodic reticle pattern 420 of FIG. 4). Accordingly, a person of ordinary skill in the art will recognize that the pattern of the spatial filter (e.g., spatial filter 520 of FIG. 5) can vary to filter out various patterns of spectral components associated with light diffracted by different target portions of the reticle. However, in an embodiment, the pattern of spatial filter 530 can be chosen to optimally filter out various patterns of spectral components associated with a variety of patterns on the reticle.

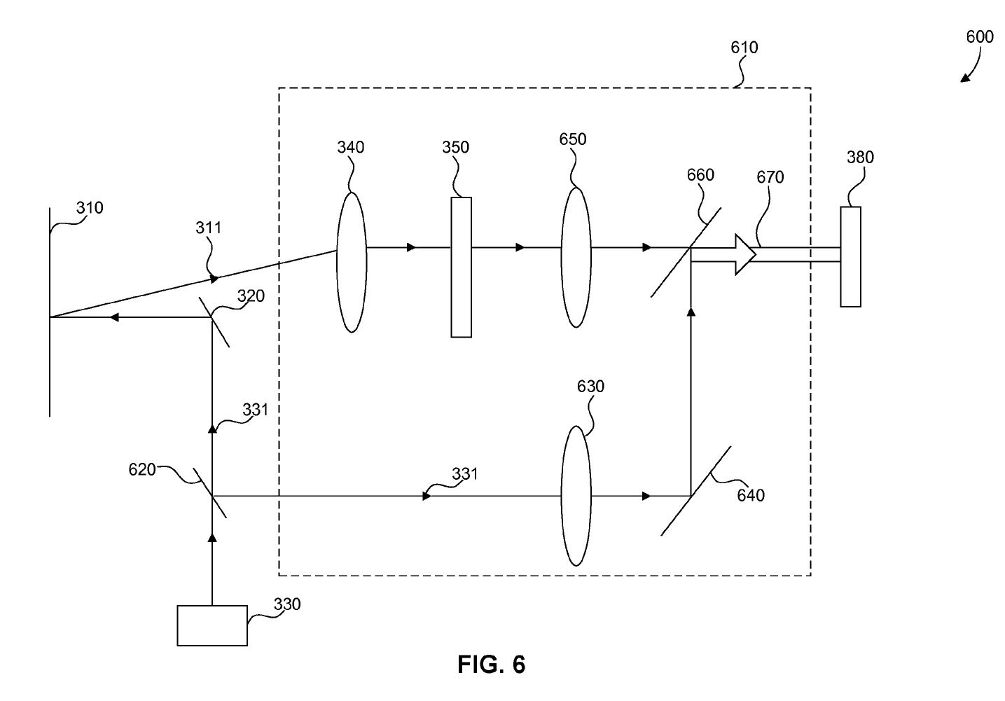

FIG. 6 is an illustration of another holographic mask inspection system 600, according to an embodiment of the present invention. Holographic mask inspection system 600 includes mirror 320, illumination source 330, image sensor 380, optical system 610, and beam splitter 620. The description for the given reticle 310, mirror 320, illumination source 330, and image sensor 380 are similar to their respective descriptions above with respect to holographic mask inspection system 300 of FIG. 3. In an embodiment, beam splitter 620 directs a portion of radiation beam 331 towards mirror 320 and another portion of radiation beam 331 towards optical system 610.

In an embodiment, optical system 610 includes objective lens 340, spatial filter 350, tube lens 630, mirror 640, tube lens 650, and beam combiner 660. The description for objective lens 340 and spatial filter 350 are similar to their respective descriptions above with respect to holographic mask inspection system 300 of FIG. 3. In an embodiment, tube lens 650 receives the portion of reflected radiation beam 311 from spatial filter 350 and transmits the portion of reflected radiation beam 311 towards beam combiner 660.

Beam combiner 660 is arranged to combine the portion of reflected radiation beam 311 with radiation beam 331 to generate a combined radiation beam 670 (e.g., interference between the portion of reflected radiation beam 311 and radiation beam 331), according to an embodiment of the present invention. In an embodiment, beam combiner 660 receives radiation beam 331 via tube lens 630 and mirror 640. Image sensor 380 receives combined radiation beam 670 from beam combiner 660, in which image sensor 380 records the resultant field from combined radiation beam 670, according to an embodiment of the present invention.

Similar to holographic mask inspection system 300 of FIG. 3, holographic mask inspection system 600 of FIG. 6 includes spatial filter 350 in a Fourier transform plane of optical system 610. In an embodiment, the placement of spatial filter 350 in the Fourier transform plane of optical system 610 removes spectral components (e.g., spectral components 511 of FIG. 5) that are embodied in the portion of the reflected radiation beam 311. This, in turn, improves the signal-to-noise ratio of the resultant field formed at beam combiner 660 and reduces registration errors in the comparison of a hologram image generated from the resultant field and a reference image.

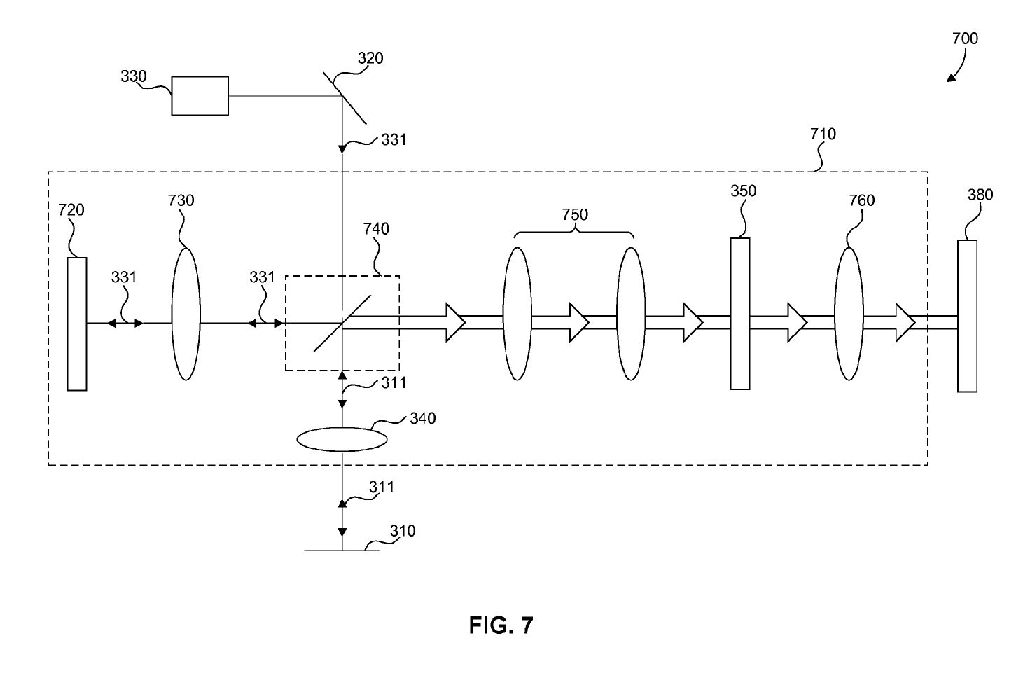

FIG. 7 is an illustration of yet another holographic mask inspection system 700, according to an embodiment of the present invention. Holographic mask inspection 700 includes illumination source 330, optical system 710, and image sensor 380. The description for the given reticle 310, mirror 320, illumination source 330, and image sensor 380 are similar to their respective descriptions above with respect to holographic mask inspection system 300 of FIG. 3.

In an embodiment, optical system 710 includes a reference mirror 720, an objective lens 730, a beam splitter and combiner 740, objective lens 340, relay lenses 750, spatial filter 350, and a tube lens 760. The description for objective lens 340 and spatial filter 350 are similar to their respective descriptions above with respect to holographic mask inspection system 300 of FIG. 3. In an embodiment, beam splitter and combiner 740 receives radiation beam 331 from mirror 320 and directs a portion of radiation beam towards objective lens 730 and another portion of radiation beam 331 towards objective lens 340. The portion of radiation beam 331 directed towards objective lens 340 is directed towards a target portion of reticle 310, in which a portion of the reflected beam 311 is directed back towards objective lens 340 and beam splitter and combiner 740, according to an embodiment of the present invention.

Further, the portion of radiation beam 331 directed towards objective lens 730 is reflected off reference mirror 720 and directed back towards objective lens 730 and beam splitter and combiner 740, according to an embodiment of the present invention. In an embodiment, reference mirror 720 is arranged such that a spatial holographic image can be generated from a resultant field of an interference between the portion of the reflected radiation beam 311 from objective lens 340 and radiation beam 331 from objective lens 730. In another embodiment, reference mirror 720 has an adjustable displacement and reflects radiation beam 331 at various optical path lengths such that a phase-shifted holographic image can be generated from the resultant field of the combined radiation beam. Methods and techniques for the generation of spatial and phase-shifted holographic images are known to a person of ordinary skill in the relevant art.

In an embodiment, beam splitter and combiner 740 is arranged to combine radiation beam 331 from objective lens 730 with the portion of reflected radiation beam 311 from objective lens 730 to generate a combined radiation beam (e.g., interference between the portion of reflected radiation beam 311 and radiation beam 331). In an embodiment, relay lenses 750 receive the combined radiation beam from beam splitter and combiner 740 and directs the combined radiation beam towards spatial filter 350. After being filtered by spatial filter 350, the combined radiation beam is received by tube lens 760, which directs the combined radiation beam towards a portion of image sensor 380.

Similar to holographic mask inspection system 300 of FIG. 3 and holographic mask inspection system 600 of FIG. 6, holographic mask inspection system 700 of FIG. 7 includes spatial filter 350 in a Fourier transform plane of optical system 710. In an embodiment, the placement of spatial filter 350 in the Fourier transform plane of optical system 710 removes spectral components (e.g., spectral components 511 of FIG. 5) that are embodied in the portion of the reflected radiation beam 311. This, in turn, improves the signal-to-noise ratio of the resultant field formed at beam splitter and combiner 740 and reduces registration errors in the comparison of a hologram image generated from the resultant field and a reference image.

Based on the description herein, a person of ordinary skill in the relevant art will recognize that embodiments of the present invention are not limited to holographic mask inspection systems 300, 600, and 700 of FIGS. 3, 6, and 7, respectively, and that other holographic mask inspection systems with various configurations of optical systems (e.g., optical systems 390, 610, and 710 of FIGS. 3, 6, and 7, respectively) can be implemented. These other holographic mask inspection systems with various configurations of optical systems are within the scope and spirit of the present invention.

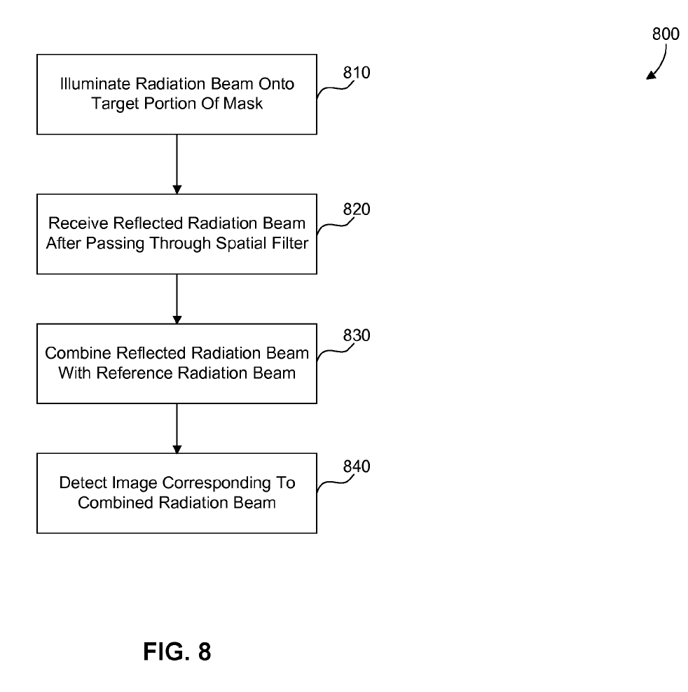

FIG. 8 is an illustration of an embodiment of a method 800 for holographic mask inspection. Method 800 can occur using, for example and without limitation, holographic mask inspection 300 of FIG. 3, holographic mask inspection system 600 of FIG. 6, or holographic mask inspection system 700 of FIG. 7. In step 810, a target portion of a mask is illuminated. The target portion of the mask can be illuminated with, for example and without limitation, illumination source 330 of FIGS. 3, 6, and 7.

In step 820, a portion of a reflected radiation beam from the target portion of the mask is received, where the portion of the reflected radiation beam passes through a spatial filter arranged in a Fourier transform plane of an optical system. As described above with respect to FIGS. 3-7, a spatial filter (e.g., spatial filter 350) can be arranged in a Fourier transform plane of an optical system so that spectral components associated with diffracted light in the reflected radiation beam can be filtered out or removed from being transmitted as part of the combined radiation beam (in step 830).

In step 830, the portion of the reflected radiation beam from the spatial filter is combined with a reference radiation beam to generate a combined radiation beam. Beam combiner 360 of FIG. 3, beam combiner 660 of FIG. 6, or beam splitter and combiner 740 of FIG. 7 can be used, for example and without limitation, to combine the portion of the reflected radiation beam from the spatial filter with the reference radiation beam.

In step 840, an image corresponding the combined radiation beam is detected with an image sensor. As described above with respect to FIG. 3, the image sensor can be a silicon charge-coupled device with an array of sensors.

In summary, with the arrangement of a spatial filter in a Fourier transform plane of an optical system in a holographic mask inspection system (e.g., holographic mask inspection system 300 of FIG. 3, holographic mask inspection system 600 of FIG. 6, and holographic mask inspection system 700 of FIG. 7), spectral components associated with diffracted light in a radiation beam reflected from a target portion of a mask can be removed. In turn, the benefits of removing these spectral components include, among others, an improvement in signal-to-noise ratio in the resultant field of the holographic image and a reduction in registration errors when comparing the holographic image of the target portion of the mask with a reference image.

### IV. Conclusion

It is to be appreciated that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A holographic mask inspection system comprising:
an illumination source configured to illuminate a radiation beam onto a target portion of a mask;
an optical system;
a spatial filter arranged in a pupil plane of the optical system, wherein the spatial filter is configured to receive at least a portion of a reflected radiation beam from the target portion of the mask and the optical system is configured to combine the portion of the reflected radiation beam with a reference radiation beam to generate a combined radiation beam; and
an image sensor configured to detect an image corresponding to the combined radiation beam.

2. The holographic mask inspection system of claim 1, further comprises a mirror, wherein the mirror is arranged to reflect the radiation beam from the illumination source onto the target portion of the mask.

3. The holographic mask inspection system of claim 1, wherein the spatial filter is configured to filter one or more spatial frequency components in the image corresponding to the reflected radiation beam.

4. The holographic mask inspection system of claim 3, wherein the spatial filter comprises a filter pattern based on a predetermined diffraction pattern produced by the target portion of the mask.

5. The holographic mask inspection system of claim 1, wherein the optical system comprises:
an objective lens configured to receive the portion of the reflected radiation beam prior to the spatial filter receiving the portion of the reflected radiation beam;
a beam combiner configured to combine the portion of the reflected radiation beam from the spatial filter with the reference radiation beam to generate the combined radiation beam, wherein the spatial filter is positioned between the objective lens and the beam combiner; and
a tube lens configured to receive the combined radiation beam and to direct the combined radiation beam onto a portion of the image sensor.

6. The holographic mask inspection system of claim 1, wherein the optical system comprises:
a mirror configured to reflect the radiation beam from the illumination source onto the target portion of the mask;
a beam splitter aged configured to direct the radiation beam towards the mirror and to produce the reference radiation beam based on the radiation beam;
an objective lens configured to receive the portion of the reflected radiation beam prior to the spatial filter receiving the portion of the reflected radiation beam;
a tube lens configured to receive the portion of the reflected radiation beam from the spatial filter, wherein the spatial filter is positioned between the objective lens and the tube lens; and
a beam combiner configured to combine the portion of the reflected radiation beam from the tube lens with the reference radiation beam to generate the combined radiation beam.

7. The holographic mask inspection system of claim 1, wherein the optical system comprises:
an objective lens configured to receive the radiation beam and the portion of the reflected radiation beam;
a reference mirror configured to receive the reference radiation beam;
a beam splitter and combiner configured to direct the radiation beam towards the objective lens and the reference mirror and to combine the portion of the reflected radiation beam with the reflection of the reference radiation beam off the reference mirror to generate the combined radiation beam;
a relay lens configured to receive the combined radiation beam; and
a tube lens configured to receive the combined radiation beam from the relay lens and to direct the combined radiation beam to a portion of the image sensor, wherein the spatial filter is positioned between the relay lens and the tube lens.

8. The holographic mask inspection system of claim 1, wherein the image sensor comprises a silicon charge-coupled device with an array of sensors.

9. The holographic mask inspection system of claim 1, wherein the image contains information corresponding to one or more mask defects on the mask.

10. A method for holographic mask inspection, comprising:
illuminating a radiation beam onto target portion of a mask;
passing at least a portion of a reflected radiation beam from the target portion of the mask through a spatial filter arranged in a pupil plane of an optical system;
combining the portion of the reflected radiation beam from the spatial filter with a reference radiation beam to generate a combined radiation beam; and
detecting an image corresponding to the combined radiation beam.

11. The method of claim 10, further comprising:
reflecting, using a mirror, the radiation beam from an illumination source onto the target portion of the mask, wherein detecting the image comprises detecting one or more mask defects on the mask.

12. The method of claim 10, wherein the passing the at least portion of the reflected radiation beam comprises filtering one or more spatial frequency components in the image corresponding to the reflected radiation beam.

13. The method of claim 12, wherein the filtering the one or more spatial frequency components comprises filtering one or more spatial frequency components based on a predetermined diffraction pattern produced by the target portion of the mask.

14. (canceled)

15. A lithography system comprising:
a first illumination system configured to condition a first radiation beam;
a support configured to support a patterning device, the patterning device configured to impart the first radiation beam with a pattern in its cross-section to form a patterned radiation beam;
a substrate table configured to hold a substrate;
a projection system configured to focus the patterned radiation beam onto the substrate; and
a holographic mask inspection system comprising:
second illumination source configured to illuminate a second radiation beam onto a target portion of the patterning device;
a spatial filter arranged in a pupil plane of an optical system, wherein the spatial filter receives at least a portion of a reflected radiation beam from the target portion of the patterning device and the optical system combines the portion of the reflected radiation beam with a reference radiation beam to generate a combined radiation beam; and
an image sensor configured to detect an image corresponding to the combined radiation beam.

16. The lithography system of claim 15, wherein the holographic mask inspection system further comprises a mirror, wherein the mirror is arranged to reflect the second radiation beam from the second illumination source onto the target portion of the patterning device.

17. The lithography system of claim 15, wherein the spatial filter is configured to filter one or more spatial frequency components in the image corresponding to the reflected radiation beam.

18. The lithography system of claim 17, wherein the spatial filter comprises a filter pattern based on a predetermined diffraction pattern produced by the target portion of the patterning device.

19. The lithography system of claim 15, wherein the optical system comprises:
an objective lens arranged to receive the portion of the reflected radiation beam prior to the spatial filter receiving the portion of the reflected radiation beam;
a beam combiner arranged to combine the portion of the reflected radiation beam from the spatial filter with the reference radiation beam to generate the combined radiation beam, wherein the spatial filter is positioned between the objective lens and the beam combiner; and
a tube lens arranged to receive the combined radiation beam and to direct the combined radiation beam onto a portion of the image sensor.

20. The lithography system of claim 15, wherein the optical system comprises:
a mirror arranged to reflect the second radiation beam from the second illumination source onto the target portion of the patterning device;
a beam splitter arranged to direct the second radiation beam towards the mirror and to produce the reference radiation beam based on the second radiation beam;
an objective lens arranged to receive the portion of the reflected radiation beam prior to the spatial filter receiving the portion of the reflected radiation beam;
a tube lens arranged to receive the portion of the reflected radiation beam from the spatial filter, wherein the spatial filter is positioned between the objective lens and the tube lens; and
a beam combiner arranged to combine the portion of the reflected radiation beam from the tube lens with the reference radiation beam to generate the combined radiation beam.

21. The lithography system of claim 15, wherein the optical system comprises:
an objective lens arranged to receive the second radiation beam and the portion of the reflected radiation beam;
a reference mirror arranged to receive the reference radiation beam;
a beam splitter and combiner arranged to direct the radiation beam towards the objective lens and the reference mirror and to combine the portion of the reflected radiation beam with the reflection of the reference radiation beam off the reference mirror to generate the combined radiation beam;
a relay lens to receive the combined radiation beam; and
a tube lens arranged to receive the combined radiation beam from the relay lens and to direct the combined radiation beam to a portion of the image sensor, wherein the spatial filter is positioned between the relay lens and the tube lens.

22-23. (canceled)
